(19) United States
(12) Patent Application Publication
(10) Pub. No.: US 2004/0254895 A1
(43) Pub. Date: Dec. 16, 2004

(54) Personal identification check method, information device, and personal identification check system

(76) Inventors: Takeshi Kumagaya, Fuchu-shi (JP); Masahiko Nozaki, Yokohama-shi (JP)

Correspondence Address: Finnegan, Henderson, Farabow,, Garrett & Dunner, L.L.P., 1300 I Street, N.W., Washington, DC, 20005-3315, US

(21) Appl. No.: 10/767,176

(22) Filed: Jan. 30, 2004

(30) Foreign Application Priority Data
Jan. 31, 2003 (JP) 2003-024852

(51) Int. Cl. G06F 17/60

(52) U.S. Cl. 705/75

(57) ABSTRACT

An information device includes a personal information reception processing section which receives personal information read from a recording medium by using a predetermined information reader, and an inquiry request/result reception section which issues, to another information device through a network, a request for an identification inquiry regarding a person indicated by the personal information received by the personal information reception processing section, and receives and outputs an identification inquiry result returned in accordance with the request.

### CROSS-REFERENCE TO RELATED APPLICATIONS

This application is based upon and claims the benefit of priority from the prior Japanese Patent Application No. 2003-024852, filed Jan. 31, 2003, the entire contents of which are incorporated herein by reference.

### BACKGROUND OF THE INVENTION

1. Field of the Invention

The present invention relates to a personal identification check method, information device, and personal identification check system used to check the identification of a person such as a visitor.

2. Description of the Related Art

Recently, for the sake of security, various techniques of checking visitors to houses and the like have been proposed.

According to a general technique, an interphone with a camera is installed at the entrance or gate of a house, and a picture of a visitor imaged by the camera is captured inside and displayed on a monitor screen, thereby checking the visitor.

The commercialization of techniques for authentication based on biometric information has recently been studied. For example, according to the technique disclosed in Jpn. Pat. Appln. KOKAI Publication No. 2002-15086, a biometric information storage section storing biometric information such as fingerprint, voiceprint, or iris information is provided in a certificate authority in advance. When a person who requests identification transmits biometric information from an identification request terminal to the certificate authority, the certificate authority transmits the inquiry result to the identification request terminal.

When an interphone with a camera or the like is used, although the user can check characteristic features such as the facial characteristics of a visitor, the user cannot check the identification of the visitor.

When biometric information is to be used, biometric information such as the fingerprint, voiceprint, or iris information of many persons must be acquired one by one and stored in a database in advance. In this case, the acquired biometric information is generally large in information amount, and hence a database capable of storing an enormous amount of information must be prepared.

In imaging and inquiring about biometric information, complicated processing such as image conversion and positioning is required. It often takes time to make an inquiry about biometric information.

It is difficult to quickly check the identification of a visitor. Furthermore, a correct authentication result cannot always be obtained.

### BRIEF SUMMARY OF THE INVENTION

Embodiments of the present invention may provide a personal identification check method, information device, and personal identification check system capable of easily checking the identification of a person.

According to one aspect of the present invention, there is provided a personal identification check method comprising reading personal information from a recording medium by using a predetermined information reader; issuing, from a first information device to a second information device through a network, a request for an identification inquiry regarding a person indicated by the read personal information; causing the second information device to perform an identification inquiry regarding the person indicated by the personal information in accordance with the request and return an inquiry result to the first information device; and causing the first information device to output the returned inquiry result.

According to another aspect of the present invention, there is provided an information device comprising a personal information reception processing section which receives personal information read from a recording medium by using a predetermined information reader; and an inquiry request/result reception section which issues, to another information device through a network, a request for an identification inquiry regarding a person indicated by the personal information received by the personal information reception processing section, and receives and outputs an identification inquiry result returned in accordance with the request.

According to still another aspect of the present invention, there is provided a personal identification check system comprising an information reader which reads personal information from a recording medium; a first information device which issues, to another information device through a network, a request for an identification inquiry regarding a person indicated by the personal information received by the personal information reception processing section, and receiving and outputting an identification inquiry result returned in accordance with the request; and a second information device which performs an identification inquiry regarding the person indicated by the personal information in accordance with the request from the first information device, and returns an inquiry result to the first information device.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing the overall arrangement of a visitor check system according to an embodiment of the present invention;

FIG. 2 is a view showing log information stored in the storage section in the house shown in FIG. 1;

FIG. 3 is a block diagram showing the functional arrangement of the home server shown in FIG. 1;

FIG. 4 is a block diagram showing the functional arrangement of the identification inquiry server shown in FIG. 1;

FIG. 5 is a view showing visitor information displayed on the screen of a display section when the home server receives personal information;

FIG. 6 is a view showing inquiry result information displayed on the screen of the display section when the home server receives the inquiry result;

FIG. 7 is a flow chart showing the operation of the information reader and home server shown in FIG. 1; and

FIG. 8 is a flow chart showing the operation of the identification inquiry server shown in FIG. 1.

### DETAILED DESCRIPTION OF THE INVENTION

Embodiments of the present invention will be described below with reference to the drawings.

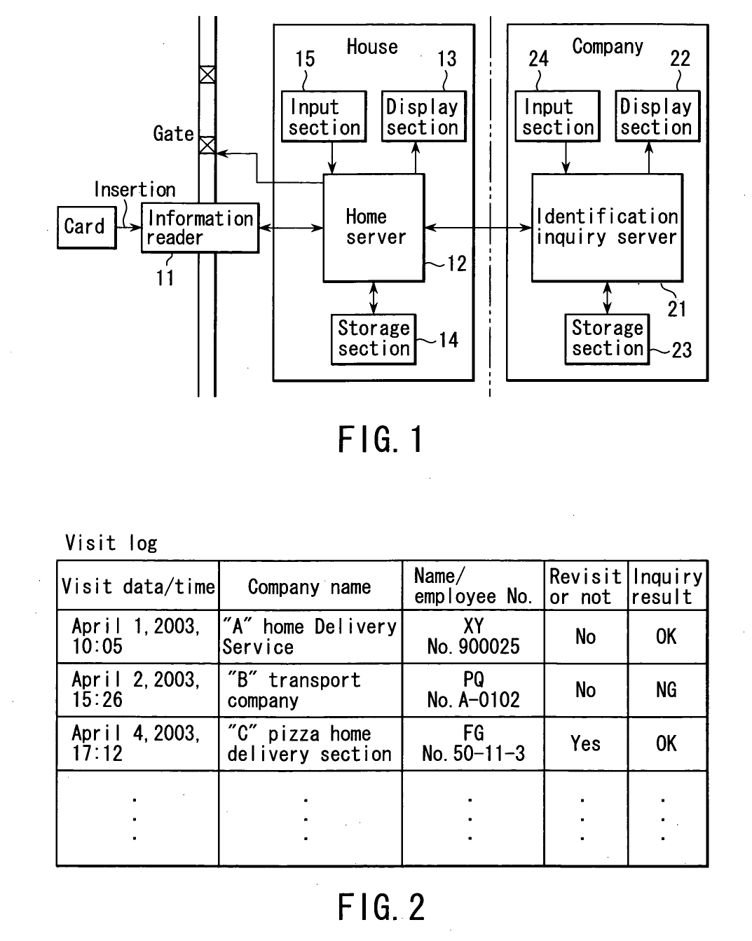

FIG. 1 is a block diagram showing the overall arrangement of a visitor check system according to an embodiment of the present invention.

The visitor check system shown in FIG. 1 is comprised of an information reader 11 which is installed at the gate or entrance of a house, a home server 12, display section 13, storage section 14, and input section 15 which are devices installed in the house, and an identification inquiry server 21, display section 22, storage section 23, and input section 24 which are devices installed in a given company.

The information reader 11 corresponds to a noncontact IC card reader or radio card reader for reading personal information (the company name, employee number, name, and the like) from a card in a predetermined form, which has a recording medium (e.g., an IC memory) on which the personal information is recorded. The information reader 11 has a card insertion slot. A visitor can insert the above card equivalent to an identification card into this slot. When the card is inserted into the slot, the information reader 11 reads the personal information recorded on the card.

The information reader 11 can perform radio communication based on a radio LAN or Bluetooth™ with the home server 12. Upon reading the personal information from the card, the information reader 11 transmits the personal information to the home server 12 upon adding current date/time information. The information reader 11 can also incorporate a sensor which detects the presence of a visitor, an output section which outputs a message to the visitor by picture or voice, an interphone which allows the visitor and the resident to talk with each other by radio, and the like. The information reader 11 also has a function of outputting a message for prompting a visitor to insert a card upon detection of the presence of the visitor or, if no card is inserted in a predetermined period of time, notifying the home server 12 of the corresponding information by radio. Note that communication between the information reader 11 and the home server 12 may be realized by wire instead of by radio.

The home server 12 in this embodiment is an information device which can perform radio communication based on a radio LAN or Bluetooth™ with the information reader 11 or can communicate with the identification inquiry server 21 installed in each company through the Internet. The home server 12 can also control the opening and closing of the gate by radio or wire in accordance with an instruction from a user. The home server 12 stores and reads out a visit log (including visit dates/times, personal information, and the like) in and from the storage section 14, displays various kinds of information on the display section 13, and processes the information input from the input section 15.

The home server 12, in particular, can issue, to the identification inquiry server 21 through the Internet, a request for an identification inquiry regarding the person indicated by the personal information received from the information reader 11, receive an identification inquiry result returned in accordance with the request, and display the result on the screen of the display section 13.

The display section 13 corresponds to a liquid crystal display device or the like, and displays various kinds of information handled by the home server 12. The storage section 14 corresponds to a hard disk drive or the like and stores a visit log and the like including personal information. The input section 15 corresponds to a keyboard and pointing device and is used to input various kinds of information.

The identification inquiry server 21 is an information device which communicates with the home sever installed in each house through the Internet. The identification inquiry server 21 also reads out the personal information of an employee of the company which is stored in the storage section 23 in advance and performs predetermined processing for the information. In addition, this server stores various kinds of information in the storage section 23, displays various kinds of information on the display section 22, and processes the information input from the input section 24.

The identification inquiry server 21, in particular, can execute an identification inquiry regarding the person indicated by personal information from the home server 12 by referring to the information in the storage section 23 in accordance with an inquiry request in the personal information, and return the inquiry result to the home server 12.

The display section 22 corresponds to a liquid crystal display device or the like, and displays various kinds of information handled by the identification inquiry server 21. The storage section 23 corresponds to a hard disk drive or the like, and has a database in which the personal information (including employee numbers, names, and the like) of the employees for the company, operation schedule information (including delivery date/time designated by customers and the like) of the employees, and the like are compiled. The input section 24 corresponds to a keyboard and pointing device and is used to input various kinds of information.

FIG. 2 is a view showing log information stored in the storage section 14 in the house shown in FIG. 1.

The log information includes various kinds of information such as “visit date/time”, “company name”, “visitor name/employee number”, “revisit or not”, or “inquiry result”. Every time a person visits the user, one line is additionally written.

“Visit date/time” indicates the date/time when a visitor visited the user. In practice, the date/time when the information reader 11 read personal information or the date/time when the home server 12 acquired personal information is used as “visit date/time”.

“Company name” and “visitor name/employee number” are obtained from the personal information read by the information reader 11.

“Revisit or not” indicates the result obtained by determining on the basis of a past log whether the same person has visited before.

“Inquiry result” is the result obtained by issuing a request for an inquiry regarding the personal information of a visitor to the identification inquiry server 21.

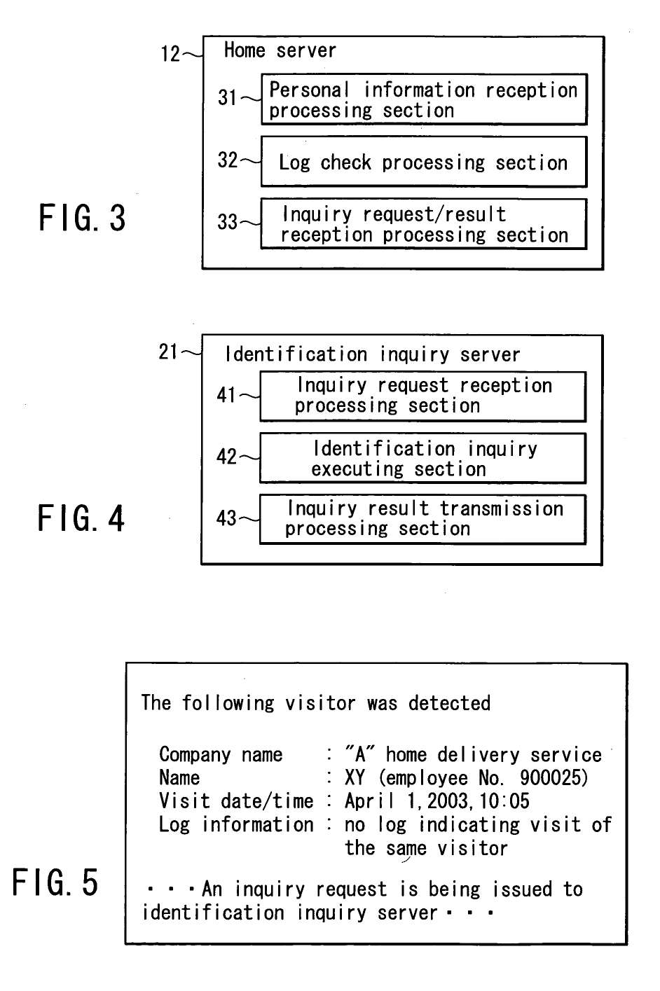

FIG. 3 is a block diagram showing the functional arrangement of the home server 12 shown in FIG. 1.

The home server 12 includes a personal information reception processing section 31, log check processing section 32, and inquiry request/result reception processing section 33.

The personal information reception processing section 31 receives, from the information reader 11, the personal information read by the information reader 11 from the card owned by a visitor, displays the information obtained by adding visit date/time information to the received personal information as visitor information on the screen of the display section 13, and stores the information as log information in the storage section 14.

Upon receiving personal information from the personal information reception processing section 31, the log check processing section 32 checks whether the same information as the personal information exists in the past log information. If such information exists, the log check processing section 32 displays the corresponding personal information in the log information and the inquiry result on the screen of the display section 13. If no such information exists, the log check processing section 32 activates the inquiry request/result reception processing section 33.

The inquiry request/result reception processing section 33 issues, to the identification inquiry server 21 in the company to which the visitor is supposed to belong through the Internet, a request for an identification inquiry regarding the person indicated by the personal information received by the personal information reception processing section 31. The inquiry request/result reception processing section 33 also receives the identification inquiry result returned in accordance with the request and displays the result on the screen of the display section 13. In addition, the inquiry request/result reception processing section 33 adds the above inquiry result to the log information of the corresponding visitor.

Note that when a request for an identification inquiry based on personal information is to be issued, the request may be transmitted to a transmission destination while the visit date/time is added to the personal information. In addition, the address of the transmission destination may be determined by referring to an address book on the basis of the company name contained in the personal information.

FIG. 4 is a block diagram showing the functional arrangement of the identification inquiry server 21 shown in FIG. 21.

The identification inquiry server 21 includes an inquiry request reception processing section 41, identification inquiry executing section 42, and inquiry result transmission processing section 43.

The inquiry request reception processing section 41 receives an inquiry request for personal information from the home server 12. The inquiry request reception processing section 41 then displays the request contents on the screen of the display section 22 and stores them in the storage section 23.

The identification inquiry executing section 42 executes an identification inquiry regarding the person indicated by the personal information in the request received by the inquiry request reception processing section 41 on the basis of the personal information of each employee stored in the storage section 23 in advance. In this identification inquiry, the inquiry request reception processing section 41 reads out, from the storage section 23, the corresponding employee number and name, the delivery date/time designated by a customer of whom the employee is in charge, and the like.

The inquiry result transmission processing section 43 returns the information read out from the storage section 23, such as the employee number and name and the delivery date/time designated by the customer, to the home server 12 as the request source through the Internet upon adding the inquiry result and company name to the information.

Note that it may also be determined whether the visit date/time indicated by the request from the home server 12 matches the delivery date/time designated by the customer, which is stored in the storage section 23, and the determination result may also be returned to the home server 12.

FIG. 5 is a view showing visitor information displayed on the screen of the display section 13 when the home server 12 receives personal information.

As shown in FIG. 5, in addition to a message indicating that a visitor is detected, the following information is displayed as visitor information: “company name” and “name/employee number” corresponding to the personal information received from the information reader 11, “visit date/time” indicating the date/time of the visit, “log information” indicating whether the same visitor visited in the past, and the like. FIG. 5 shows a case wherein the same visitor did not visit in the past.

If the same visitor visited the user in the past, the message “there is a log indicating the visit of the same visitor in the past” is displayed in the box of “log information”, and the past visit date/time and inquiry result are also simultaneously displayed. In this case, a dialog for prompting the user to designate whether to issue an inquiry request to the identification inquiry server 21 may be displayed.

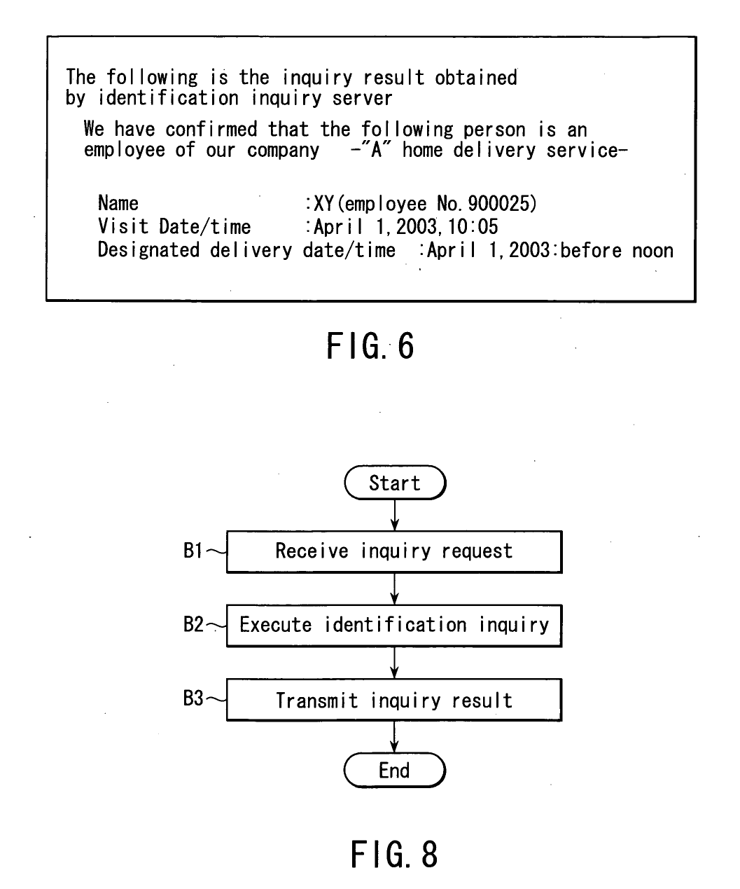

FIG. 6 is a view showing inquiry result information to be displayed on the screen of the display section 13 when the home server 12 receives an inquiry result.

As shown in FIG. 6, as a message from the corresponding company, inquiry result information is displayed, which includes, for example, “name/employee number” of an employee of the company, “visit date/time” when the employee actually visited, and “designated delivery date/time” as the date/time designated by the customer. FIG. 6 shows a case wherein the authentication result is OK (no problem).

If the authentication result is NG (with problem), a message like “Our company does not have such an employee” is displayed. In addition, even if the authentication result is OK, when “visit date/time” does not match “designated delivery date/time”, a message indicating this may be displayed.

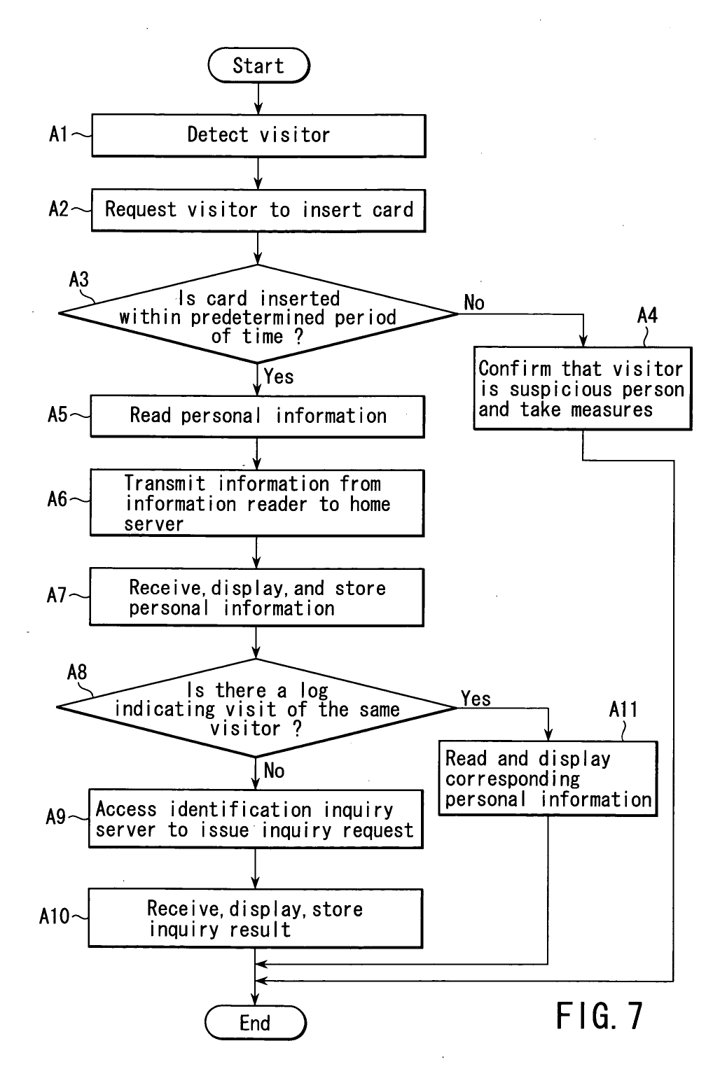

The operation of the information reader 11 and home server 12 will be described next with reference to FIG. 7.

Upon detecting a visitor with a sensor (step A1), the information reader 11 displays a message or the like to request the visitor to insert a card (step A2).

It is checked whether the card is inserted within a predetermined period of time after the visitor is requested (step A3). If no card is inserted within the predetermined period of time (NO in step A3), the visitor is a suspicious person. The information reader 11 then notifies the home server 12 of the corresponding information or, for example, records the information obtained by imaging with a camera (step A4), and terminates the processing.

If the card is inserted within the predetermined period of time (YES in step A3), the information reader 11 reads personal information stored in the card (step A5), and transmits the personal information to the home server 12 by radio (step A6).

Upon receiving the personal information transmitted from the information reader 11, the home server 12 displays information obtained by adding visit date/time information to the received personal information as visitor information on the screen of the display section 13, and stores it as log information in the storage section 14 (step A7).

The home server 12 then checks whether the same information as the received personal information exists in the past log information (step A8). If no such information exists (NO in step A8), the home server 12 issues, to the identification inquiry server 21 through the Internet, a request for an identification inquiry regarding the person indicated by the received personal information (step A9). Upon receiving the identification inquiry result returned in accordance with the request, the home server 12 displays the result on the screen of the display section 13 and adds the inquiry result to the log information of the corresponding visitor (step A10).

If it is determined in step A8 that the same information as the received personal information exists in the past log information (YES in step A8), the home server 12 displays the corresponding personal information in the log information and the inquiry result on the screen of the display section 13 (step A11).

The operation of the identification inquiry server 21 will be described next with reference to the flow chart of FIG. 8.

Upon receiving an inquiry request for personal information from the home server 12, the identification inquiry server 21 displays the request contents on the screen of the display section 22 and stores them in the storage section 23 (step B1).

The identification inquiry server 21 executes an identification inquiry regarding the person indicated by the personal information in the received request on the basis of the personal information of each employee stored in the storage section 23 (step B2). In this identification inquiry, the identification inquiry server 21 reads out the corresponding employee number and name, the delivery date/time designated by a customer of whom the employee is in charge, and the like from the storage section 23.

Finally, the identification inquiry server 21 returns, to the home server 12 as the request source through the Internet, information obtained by adding the inquiry result and company name to the information read out from the storage section 23, including the employee number and name, the delivery date/time designated by the customer of whom the employee is in charge, and the like (step B3).

As described above, according to this embodiment, the home server issues, to an identification inquiry sever in a predetermined company, a request for an identification inquiry regarding the person indicated by the personal information read by the information reader, and displays the obtained inquiry result on the screen of the display section. This allows the resident to easily check the identification of a visitor.

As has been described in detail above, according to the present invention, it is possible to easily check the identification of a person.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A personal identification check method comprising:
reading personal information from a recording medium by using a predetermined information reader;
issuing, from a first information device to a second information device through a network, a request for an identification inquiry regarding a person indicated by the read personal information;
causing the second information device to perform an identification inquiry regarding the person indicated by the personal information in accordance with the request and return an inquiry result to the first information device; and
causing the first information device to output the returned inquiry result.

2. The method according to claim 1, further comprising displaying the inquiry result on a screen.

3. The method according to claim 1, further comprising storing log information including the personal information in a predetermined storage area.

4. The method according to claim 3, further comprising adding the inquiry result to the log information.

5. The method according to claim 4, further comprising determining, upon reading given personal information, whether same information as the personal information exists in the log information, and, if the same information exists in the log information, outputting corresponding personal information and an inquiry result.

6. An information device comprising:
a personal information reception processing section which receives personal information read from a recording medium by using a predetermined information reader; and
an inquiry request/result reception section which issues, to another information device through a network, a request for an identification inquiry regarding a person indicated by the personal information received by the personal information reception processing section, and receives and outputs an identification inquiry result returned in accordance with the request.

7. The device according to claim 6, wherein the inquiry request/result reception section displays the inquiry result on a screen.

8. The device according to claim 6, wherein the personal information reception processing section stores log information including the received personal information in a predetermined storage area.

9. The device according to claim 8, wherein the inquiry request/result reception section adds the inquiry result to the log information.

10. The device according to claim 9, further comprising a log check processing section which determines, when personal information is received by the personal information reception processing section, whether same information as the personal information exists in the log information, and, if the same information exists, outputs corresponding personal information in the log information and an inquiry result.

11. A personal identification check system comprising:
an information reader which reads personal information from a recording medium;
a first information device which issues, to another information device through a network, a request for an identification inquiry regarding a person indicated by the personal information received by the personal information reception processing section, and receiving and outputting an identification inquiry result returned in accordance with the request; and
a second information device which performs an identification inquiry regarding the person indicated by the personal information in accordance with the request from the first information device, and returns an inquiry result to the first information device.

12. The system according to claim 11, wherein the first information device displays the inquiry result on a screen.

13. The system according to claim 11, wherein the first information device stores log information including the received personal information in a predetermined storage area.

14. The system according to claim 13, wherein the first information device adds the inquiry result to the log information.

15. The system according to claim 14, wherein the first information device determines, when personal information is received by the personal information reception processing section, whether same information as the personal information exists in the log information, and, if the same information exists, outputs corresponding personal information in the log information and an inquiry result.
